(19) United States
(12) Patent Application Publication
(10) Pub. No.: US 2018/0311102 A1
(43) Pub. Date: Nov. 1, 2018

(54) MUSCLE STRETCHING DEVICE

(71) Applicant: Andrew Maurice Frankson, Poughkeepsie, NY (US)

(72) Inventor: Andrew Maurice Frankson, Poughkeepsie, NY (US)

(21) Appl. No.: 15/890,498

(22) Filed: Feb. 7, 2018

Related U.S. Application Data
(60) Provisional application No. 62/490,430, filed on Apr. 26, 2017.

(51) Int. Cl. A61H 1/02; A63B 21/00; A63B 23/04

(52) U.S. Cl. CPC A61H 1/0237; A63B 21/00047; A63B 21/00069; A63B 2023/006; A63B 21/4034; A63B 23/0494; A63B 23/0488; A63B 21/00185

(57) ABSTRACT

A muscle stretching device. A first base and a second base each include a foot adjustment portion and a connector portion. The connector portion of the first base is coupled to the connector portion of the second base. The connector portions are adjustable to adjust a distance between the foot adjustment portions. A right foot support is pivotally coupled to the foot adjustment portion of the first base and is rotatable relative to the first base about a first vertical axis. A left foot support is pivotally coupled to the foot adjustment portion of the second base and is rotatable relative to the second base about a second vertical axis.

### CROSS-REFERENCE TO RELATED APPLICATION

This application claims the benefit of priority of U.S. provisional application No. 62/490,430, filed Apr. 26, 2017, the contents of which are herein incorporated by reference.

### BACKGROUND OF THE INVENTION

The present invention relates to a muscle stretching device and, more particularly, to a device that stretches muscles in the lateral pelvis and lateral lower leg.

Patients may have tight deep muscle issues due to overly contracted muscles in the lateral pelvis and lateral lower leg. Certain devices are used to stretch the pelvis and lower leg area but fail to stretch the lateral rotators and abductors of the thigh at the hip and foot at the ankle.

As can be seen, there is a need for a muscle stretching device that targets smaller muscles in the lateral pelvis and lateral lower leg.

### SUMMARY OF THE INVENTION

In one aspect of the present invention, a muscle stretching device comprises: a first base and a second base each comprising a foot adjustment portion and a connector portion, wherein the connector portion of the first base is coupled to connector portion of the second base, the connector portions being adjustable to adjust a distance between the foot adjustment portions; a right foot support pivotally coupled to the foot adjustment portion of the first base and rotatable relative to the first base about a first vertical axis and a left foot support pivotally coupled to the foot adjustment portion of the second base and rotatable relative to the second base about a second vertical axis; and a first locking mechanism configured to lock the right foot support to the foot adjustment portion of the first base at different angles relative to a horizontal axis and a second locking mechanism configured to lock the left foot support to the foot adjustment portion of the second base at different angles relative to the horizontal axis.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a top exploded view of an embodiment of the present invention;

FIG. 3 is a bottom exploded view of an embodiment of the present invention;

FIG. 4 is a detail perspective view of an embodiment of the present invention;

FIG. 5 is a section view of the present invention, taken along line 5-5 in FIG. 1;

FIG. 6 is a section view of the present invention, taken along line 6-6 in FIG. 1;

FIG. 7 is a top view of an embodiment of the present invention; and

FIG. 8 is a top view of the present invention illustrating foot supports disposed at different angles relative to a base.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

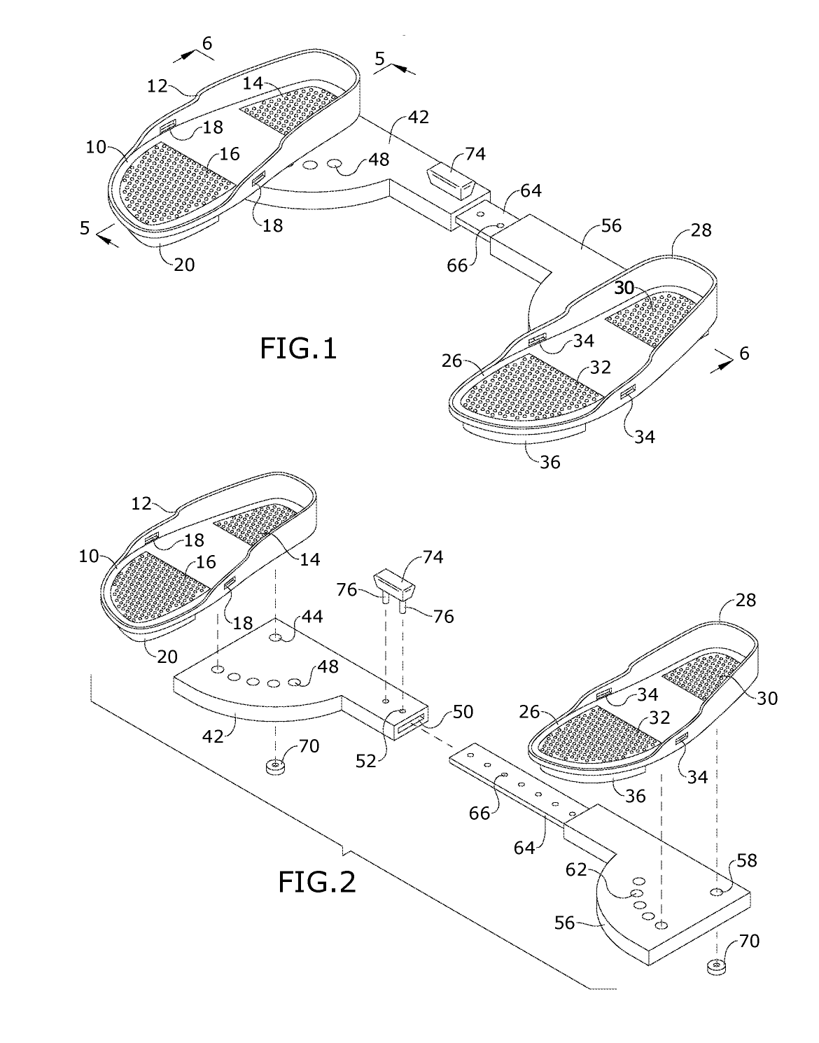

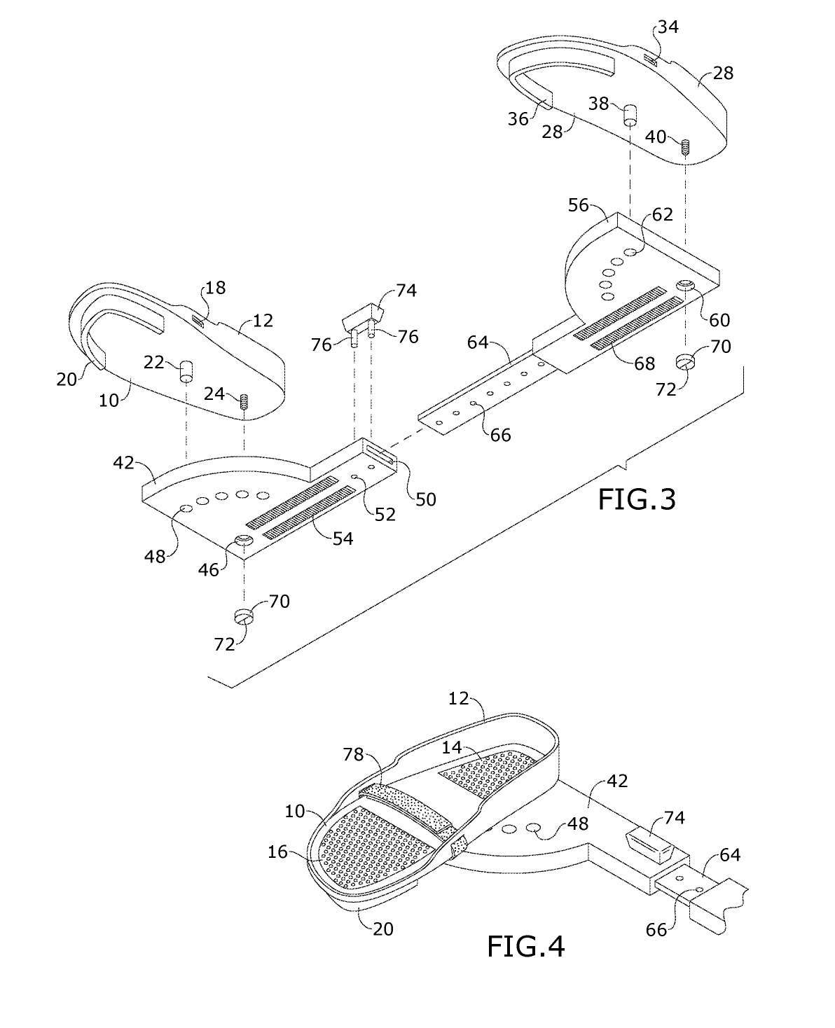

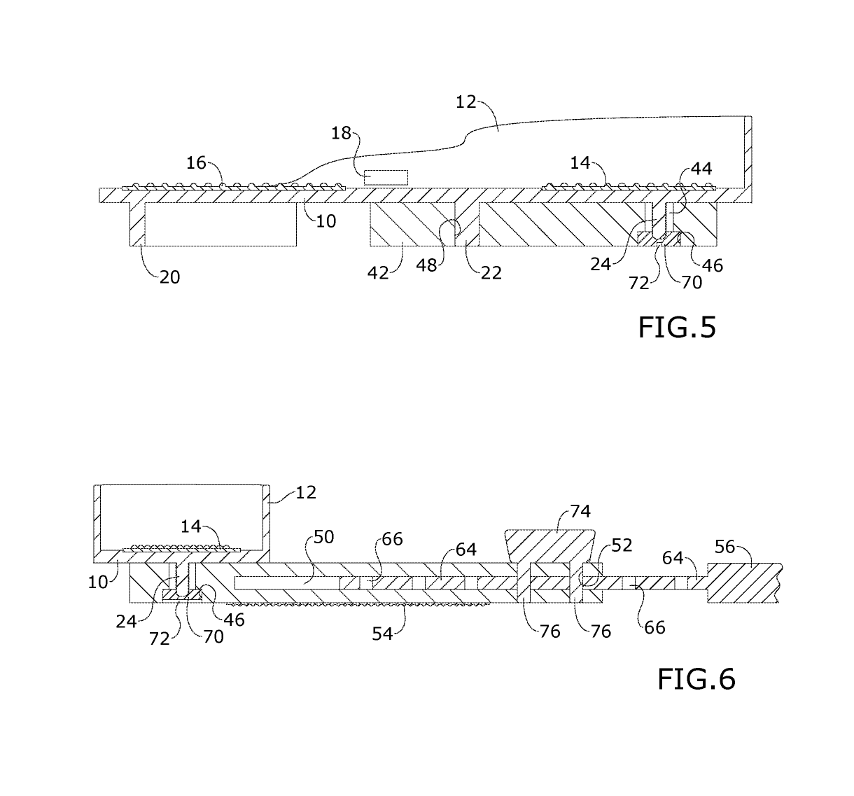

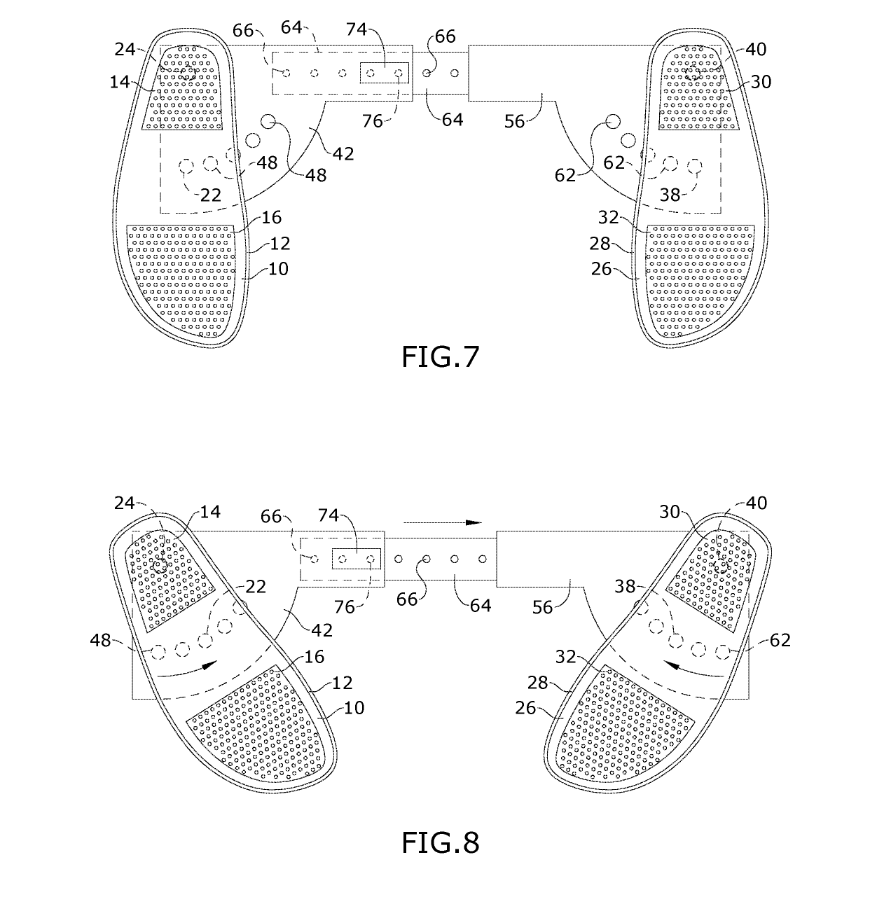

Referring to FIGS. 1 through 8, the present invention includes a muscle stretching device. The muscle stretching device includes a first base 42 and a second base 56. The first base 42 and the second base 56 each include a foot adjustment portion and a connector portion. The connector portion of the first base 42 is coupled to the connector portion of the second base 56. The connector portions are adjustable to adjust a distance between the foot adjustment portions. The muscle stretching device further includes a right foot support 10 pivotally coupled to the foot adjustment portion of the first base 42 and rotatable relative to the first base about a first vertical axis. A left foot support 26 is pivotally coupled to the foot adjustment portion of the second base 56 and is rotatable relative to the second base 56 about a second vertical axis. A first locking mechanism 22, 48 is configured to lock the right foot support 10 to the foot adjustment portion of the first base 42 at different angles relative to a horizontal axis and a second locking mechanism 38, 62 is configured to lock the left foot support 26 to the foot adjustment portion of the second base 56 at different angles relative to the horizontal axis.

In certain embodiments, the first locking mechanism 22, 48 includes an angle adjustment peg 22 extending from a bottom surface of the right foot support 10. A plurality of angle adjustment openings 48 are formed through the foot adjustment portion of the first base 42. The plurality of angle adjustment openings 48 are arranged radially relative to the first vertical axis. The angle adjustment peg 22 fits within the plurality of angle adjustment openings 48. The second locking mechanism 38, 62 includes an angle adjustment peg 38 extending from a bottom surface of the left foot support 26. A plurality of angle adjustment openings 62 are formed through the foot adjustment portion of the second base 56. The plurality of angle adjustment openings 62 are arranged radially relative to the second vertical axis. The angle adjustment peg 38 fits within the plurality of angle adjustment openings 62.

In certain embodiments, the connector portions of the bases 42, 56 includes an adjustment arm 64 including a plurality of adjustment holes 66 and an adjustment sleeve 50 including at least one adjustment hole 52, such as two adjustment holes 52. The adjustment arm 64 slidably engages within the adjustment sleeve 50. At least one locking peg 76, such as a pair of locking pegs 76, may extend from a peg handle 74. The locking pegs 76 are sized to fit within aligned adjustment holes 52, 66 of the adjustment arm 64 and the adjustment sleeve 50, thereby locking the connector portions of the bases 42, 56 together.

The right foot support 10 and the left foot support 26 may each include the shape of a sole of a shoe. The right foot support 10 may include an upper surface and a rubberized gripping 14 attached to the upper surface. The left foot support 26 may also include an upper surface and a rubberized gripping 30 attached to the upper surface. The right foot support 10 may further include an outer edge and a sidewall 12 extending vertically from the outer edge. The left foot support 10 may further include an outer edge and a sidewall 28 extending vertically from the outer edge. The sidewall 12 of the right foot support 10 includes openings 18 formed through opposing sides and the sidewall 28 of the left foot support 26 includes openings 34 formed through opposing sides. Hook and loop straps 78 may be secured to the right foot support 10 and the left foot support 26 via the openings 18, 34.

In certain embodiments, a lift wall 20 may extend from a lower surface of a front portion of the right foot support 10 and a lift wall 36 may extend from a lower surface of a front portion of the left foot support 26. In such embodiments, the front portions of the right and left foot supports 10, 26 may extend beyond the first and second base 42, 56 respectively. Therefore, the lift walls 20, 36 may support the front portions of the right and left foot supports 10, 26 on a surface in which the present invention is placed upon.

In certain embodiments, the first base 42 and the second base 56 each include a lower surface. A rubberized gripping 54 may be attached to the lower surface of the first base 42 and a rubberized gripping 68 may be attached to the lower surface of the second base 56. The rubberized gripping 54, 68 prevent the first and second base 42, 56 from sliding on a floor.

In certain embodiments, the right foot support 10 is pivotally coupled to the first base 42 by a threaded rod 24 extending from a bottom surface of the right foot support 10. An opening 44 is formed through the foot adjustment portion of the first base 42. The threaded rod 24 runs through the opening 44. A threaded nut 70 with a nut slot 72 is threadably fastened to an end of the threaded rod 24 and is disposed within a countersunk portion 46 formed on a bottom surface of the first base 42. The left foot support 26 is pivotally coupled to the second base 56 by a threaded rod 40 extending from a bottom surface of the left foot support 26. An opening 58 is formed through the foot adjustment portion of the second base 56. The threaded rod 40 runs through the opening 58. A threaded nut 70 with a nut slot 72 is threadably fastened to an end of the threaded rod 40 and is disposed within a countersunk portion 60 formed on a bottom surface of the second base 56.

To use the present invention, the user first adjusts the distance between the foot supports 10, 26 by removing the locking pegs 76 from the aligned adjustment holes 52, 66 and sliding the adjustment arm 64 relative to the adjustment sleeve 50 to set the foot supports 10, 26 at a desired distance. Then the locking pegs 76 are placed within the aligned adjustment holes 52, 66 to lock the arm 64 and the sleeve 50 in place. The user then adjusts the angles of the foot supports 10, 26 by removing the nuts 70 from the threaded rods 24, 40, removing the foot supports 10, 26 from the foot adjustment portions, and then placing the angle adjustment pegs 22, 38 into an opening 48, 62 that corresponds with a desired angle. The nuts 70 are then fastened back onto the threaded rods 24, 40. The present invention is then set on the floor. The user places their feet in the foot supports 10, 26 and relaxes. The angle of the feet urges the knees to medially rotate which passively stretches the deep muscles without the assistance of a second user.

It should be understood, of course, that the foregoing relates to exemplary embodiments of the invention and that modifications may be made without departing from the spirit and scope of the invention as set forth in the following claims.

What is claimed is:

1. A muscle stretching device comprising:
a first base and a second base each comprising a foot adjustment portion and a connector portion, wherein the connector portion of the first base is coupled to connector portion of the second base, the connector portions being adjustable to adjust a distance between the foot adjustment portions;
a right foot support pivotally coupled to the foot adjustment portion of the first base and rotatable relative to the first base about a first vertical axis and a left foot support pivotally coupled to the foot adjustment portion of the second base and rotatable relative to the second base about a second vertical axis; and
a first locking mechanism configured to lock the right foot support to the foot adjustment portion of the first base at different angles relative to a horizontal axis and a second locking mechanism configured to lock the left foot support to the foot adjustment portion of the second base at different angles relative to the horizontal axis.

2. The muscle stretching device of claim 1, wherein the first locking mechanism and the second locking mechanism each comprise an angle adjustment peg extending from a bottom surface of the right foot support and the left foot support respectively, and a plurality of angle adjustment openings formed through the foot adjustment portion of the first base and the foot adjustment portion of the second base respectively, wherein the angle adjustment pegs fit within the plurality of angle adjustment openings.

3. The muscle stretching device of claim 2, wherein the plurality of angle adjustment openings are arranged radially relative to the vertical axes.

4. The muscle stretching device of claim 1, wherein the connector portions comprise an adjustment arm comprising a plurality of adjustment holes and an adjustment sleeve comprising at least one adjustment hole, wherein the adjustment arm slidably engages with adjustment sleeve.

5. The muscle stretching device of claim 4, further comprising a locking peg sized to fit within aligned adjustment holes of the adjustment arm and the adjustment sleeve.

6. The muscle stretching device of claim 1, wherein each of the right foot support and the left foot support further comprises an upper surface and a rubberized gripping attached to the upper surface.

7. The muscle stretching device of claim 1, wherein each of the right foot support and the left foot support further comprises an outer edge and a sidewall extending vertically from the outer edge.

8. The muscle stretching device of claim 7, wherein the sidewalls each comprise openings formed through opposing sides and hook and loop straps disposed within the openings.

9. The muscle stretching device of claim 1, wherein each of the first base and the second base comprise a lower surface and a rubberized gripping attached to the lower surface.

10. The muscle stretching device of claim 1, wherein each of the right foot support and the left foot support are pivotally coupled to the first base and the second base respectively by a threaded rod extending from a bottom surface of the foot support and running through an opening of the foot adjustment portion, wherein a nut is threadably fastened to an end of the threaded rod and disposed within a countersunk portion of the opening.
